(19) United States
(12) Patent Application Publication
(10) Pub. No.: US 2019/0345314 A1
(43) Pub. Date: Nov. 14, 2019

(54) TREAD FOR A TIRE

(71) Applicant: Compagnie Generale Des Etablissements Michelin, Clermont-Ferrand (FR)

(72) Inventors: Perrine Vallat, Clermont-Ferrand (FR); Damien Thomasson, Clermont-Ferrand (FR)

(21) Appl. No.: 16/462,983

(22) PCT Filed: Nov. 27, 2017
(86) PCT No.: PCT/FR2017/053256

§ 371 Date: May 22, 2019

(30) Foreign Application Priority Data
Nov. 28, 2016 (FR) 1661574

(51) Int. Cl. C08L 7/00; B60C 1/00

(52) U.S. Cl. CPC C08L 7/00; C08L 2205/03; C08L 2205/06; B60C 1/0016

(57) ABSTRACT

The tire tread has a rubber composition that is based on at least one natural or synthetic polyisoprene, at a content ranging from 50 phr to 90 phr, a reinforcing filler predominantly comprising an inorganic filler by weight, a coupling agent, a plasticizing agent at a content of less than or equal to 10 phr and a sulfur-based crosslinking system. The coupling agent consists of a silane polysulfide, and the silane content of the composition ranges from 12% to 20% by weight relative to the amount of inorganic filler.

The present invention relates to diene rubber compositions, predominantly reinforced by an inorganic filler such as silica, which may be used for the manufacture of tyre treads, and more particularly for tyres intended to be fitted to vehicles carrying heavy loads and running at sustained speeds, for example trucks, tractors, trailers or buses, aeroplanes, etc.

Some current tyres, referred to as “road” tyres, are intended to run at high speed and over increasingly long journeys, as a result of the improvement in the road network and of the growth of the motorway network throughout the world. However, since fuel savings and the need to protect the environment have become a priority, it has proved necessary to produce tyres having a reduced rolling resistance without adversely affecting their wear resistance.

This has been made possible especially by virtue of the use, in the treads of these tyres, of novel rubber compositions reinforced at least partially with inorganic fillers. In particular, these are specific silicas of highly dispersible type, which are capable of rivalling, from a reinforcing perspective, a conventional tyre-grade carbon black, while affording these compositions a lower hysteresis, which is synonymous with lower rolling resistance for the tyres comprising them.

However, there remains a need to further improve the properties of these compositions for treads.

In point of fact applicant has found, surprisingly, that it was possible, in compositions predominantly based on natural rubber and on inorganic filler, to at the same time improve the stiffness and hysteresis properties and the properties of processing in the uncured state of these compositions using high contents of silane polysulfides.

Indeed, in order to couple the reinforcing inorganic filler to the diene elastomer, use is made, in a well-known way, of an at least bifunctional coupling agent (or bonding agent) intended to provide a satisfactory connection, of chemical and/or physical nature, between the inorganic filler (surface of its particles) and the diene elastomer. Use is made in particular of at least bifunctional organosilanes or polyorganosiloxanes. So as not to run the risk of influencing other interactions of the constituents of the composition, those skilled in the art know that it is desirable to use the bare minimum required of coupling agent, i.e. as is known approximately 8 to 10% by weight of the amount of inorganic filler.

However, counter to these principles, the applicant noticed that, by significantly increasing the content of such silane polysulfides in compositions having low plasticizer contents, predominantly based on natural rubber in the elastomer matrix and predominantly on inorganic filler as reinforcing filler, it was possible to achieve an unexpected compromise of properties, exhibiting both an improvement in the properties in the uncured state (processing) and in the cured state (hysteresis and stiffness).

Consequently, a first subject of the invention relates to a tyre tread having a rubber composition based on at least one natural or synthetic polyisoprene, at a content ranging from 50 phr to 100 phr, a reinforcing filler predominantly comprising an inorganic filler by weight, a coupling agent, a plasticizing agent at a content of less than or equal to 10 phr and a sulfur-based crosslinking system, characterized in that the coupling agent consists of a silane polysulfide and in that the silane content of the composition ranges from 12% to 20% by weight relative to the amount of inorganic filler.

Preferentially, the composition also comprises a polybutadiene, BR, or a butadiene-styrene copolymer, SBR, the content of polyisoprene ranging from 50 phr to 90 phr.

According to a preferential variant of the invention, the inorganic filler comprises silica, and more preferentially still, the inorganic filler consists of silica.

Advantageously, the silane content ranges from 12% to 16% by weight, preferably 13% to 16% by weight, relative to the amount of inorganic filler.

According to a variant embodiment of the invention, the inorganic filler represents at least 60% by weight of the reinforcing filler, preferably at least 75% by weight and more preferentially still at least 90% by weight.

According to one embodiment of the invention, the composition comprises a BR or an SBR at a content ranging from 10 to 50 phr; the content of polyisoprene preferably ranges from 60 to 90 phr and the content of BR or SBR ranges from 10 to 40 phr.

According to another embodiment of the invention, the content of polyisoprene ranges from 50 to 80 phr and the composition comprises BR at a content of 10 to 40 phr and SBR at a content of 10 to 40 phr.

Advantageously, the content of plasticizing agent is less than or equal to 5 phr, preferably less than or equal to 2 phr.

The invention also relates to a tyre comprising a tread as described above.

### I. MEASUREMENTS AND TESTS USED

The rubber compositions are characterized, before and after curing, as indicated below.

### Mooney Plasticity

Use is made of an oscillating consistometer as described in French standard NF T 43-005 (November 1980). The Mooney plasticity measurement is carried out according to the following principle: the composition in the uncured state (i.e., before curing) is moulded in a cylindrical chamber heated to 100° C. After preheating for one minute, the rotor rotates within the test specimen at 2 revolutions/minute and the working torque for maintaining this movement is measured after rotating for 4 minutes. The Mooney plasticity (ML 1+4) is expressed in “Mooney unit” (MU, with 1 MU=0.83 newton.metre).

### Dynamic Properties

The dynamic properties ΔG* and tan(δ)ₘₐₓ are measured on a viscosity analyser (Metravib VA4000) according to standard ASTM D 5992-96. The response of a sample of vulcanized composition (cylindrical test specimen with a thickness of 4 mm and a cross section of 400 mm²), subjected to a simple alternating sinusoidal shear stress, at a frequency of 10 Hz, under standard temperature conditions (60° C.) according to standard ASTM D 1349-99 or, as the case may be, at a different temperature, is recorded. A strain amplitude sweep is carried out from 0.1% to 100% (outward cycle) and then from 100% to 0.1% (return cycle). The results made use of are the complex dynamic shear modulus (G*) and the loss factor tan(δ). The maximum value of tan (δ) observed, denoted tan(δ)ₘₐₓ, and the difference in complex modulus (ΔG*) between the values at 0.1% and at 100% strain (Payne effect) are shown for the return cycle.

### II. DETAILED DESCRIPTION OF THE INVENTION

The invention relates to a tyre tread having a rubber composition based on at least on at least one natural or synthetic polyisoprene, at a content ranging from 50 phr to 90 phr, a reinforcing filler predominantly comprising an inorganic filler by weight, a coupling agent, a plasticizing agent at a content of less than or equal to 10 phr and a sulfur-based crosslinking system, characterized in that the coupling agent consists of a silane polysulfide and in that the silane content of the composition ranges from 12% to 20% by weight relative to the amount of inorganic filler.

Preferentially, the composition also comprises a polybutadiene, BR, or a butadiene-styrene copolymer, SBR, the content of polyisoprene ranging from 50 phr to 90 phr.

It should be noted that, in the concept of phr: “parts by weight per hundred parts of elastomer”, the combination of all of the elastomers present in the final composition is taken into consideration.

In the present description, unless expressly indicated otherwise, all the percentages (%) shown are % by weight. Furthermore, any range of values denoted by the expression “between a and b” represents the range of values extending from more than a to less than b (that is to say, limits a and b excluded), whereas any range of values denoted by the expression “from a to b” means the range of values extending from a up to b (that is to say, including the strict limits a and b).

### Diene Elastomer

As is customary, the terms “elastomer” and “rubber”, which are interchangeable, are used without distinction in the text.

A “diene” elastomer or rubber should be understood, in a known way, as meaning an elastomer resulting at least in part (i.e., a homopolymer or a copolymer) from diene monomers (monomers bearing two conjugated or non-conjugated carbon-carbon double bonds).

These diene elastomers can be classified into two categories: “essentially unsaturated” or “essentially saturated”. “Essentially unsaturated” is generally understood to mean a diene elastomer resulting at least in part from conjugated diene monomers having a content of units of diene origin (conjugated dienes) which is greater than 15% (mol %); thus, diene elastomers such as butyl rubbers or copolymers of dienes and of α-olefins of EPDM type do not come within the preceding definition and can especially be described as “essentially saturated” diene elastomers (low or very low content, always less than 15%, of units of diene origin). In the category of “essentially unsaturated” diene elastomers, “highly unsaturated” diene elastomer is understood in particular to mean a diene elastomer having a content of units of diene origin (conjugated dienes) which is greater than 50%.

According to the invention, the predominant diene elastomer is preferably an isoprene elastomer, that is to say an isoprene homopolymer or copolymer, in other words a diene elastomer selected from the group consisting of natural rubber (NR), synthetic polyisoprenes (IRs), various isoprene copolymers or a mixture of these elastomers. Mention will in particular be made, among isoprene copolymers, of isobutene-isoprene (butyl rubber—IIR), isoprene-styrene (SIR), isoprene-butadiene (BIR) or isoprene-butadiene-styrene (SBIR) copolymers. This isoprene elastomer is preferably natural rubber or a synthetic cis-1,4-polyisoprene; use is preferably made, among these synthetic polyisoprenes, of polyisoprenes having a content (mol %) of cis-1,4-bonds of greater than 90%, more preferentially still of greater than 98%.

When the composition is prepared with a liquid-phase compounding process in order to obtain masterbatches based on natural rubber and reinforcing filler, use is made of a natural rubber latex, the elastomer latex being a specific form of the elastomer in the form of elastomer particles dispersed in water.

More particularly, natural rubber (NR) exists in various forms, as explained in detail in Chapter 3, “Latex concentrates: properties and composition”, by K. F. Gaseley, A. D. T. Gordon and T. D. Pendle in “Natural Rubber Science and Technology”, A. D. Roberts, Oxford University Press—1988.

In particular, several forms of natural rubber latex are sold: the natural rubber latexes referred to as “field latexes”, the natural rubber latexes referred to as “concentrated natural rubber latexes”, epoxidized latexes (ENRs), deproteinized latexes or else prevulcanized latexes. Natural rubber field latex is a latex to which ammonia has been added in order to prevent premature coagulation and concentrated natural rubber latex corresponds to a field latex which has undergone a treatment corresponding to a washing, followed by a further concentration. The various categories of concentrated natural rubber latexes are listed in particular according to standard ASTM D 1076-06. Singled out in particular among these concentrated natural rubber latexes are the concentrated natural rubber latexes of the grade referred to as: “HA” (high ammonia) and of the grade referred to as “LA”; for the invention, use will advantageously be made of concentrated natural rubber latexes of HA grade.

The NR latex can be physically or chemically modified beforehand (centrifugation, enzymatic treatment, chemical modifier, etc.).

The latex can be used directly or be diluted beforehand in water to facilitate the processing thereof.

Of course, it is possible to envisage the compositions in accordance with the invention containing a blend with another diene or non-diene elastomer.

In the group of highly unsaturated diene elastomers, polybutadienes (abbreviated to “BRs”), butadiene copolymers, isoprene copolymers and the mixtures of these elastomers are suitable in particular as such. Such copolymers are more preferentially selected from the group consisting of butadiene-styrene copolymers (SBRs), isoprene-butadiene copolymers (BIRs), isoprene-styrene copolymers (SIRs) and isoprene-butadiene-styrene copolymers (SBIRs).

The abovementioned elastomers may have any microstructure, which depends on the polymerization conditions used, especially on the presence or absence of a modifying and/or randomizing agent and on the amounts of modifying and/or randomizing agent employed. The elastomers can, for example, be block, random, sequential or microsequential elastomers and can be prepared in dispersion or in solution; they can be coupled and/or star-branched or else functionalized with a coupling and/or star-branching or functionalization agent. For coupling to carbon black, mention may for example be made of functional groups comprising a C—Sn bond or aminated functional groups, such as aminobenzophenone, for example; for coupling to a reinforcing inorganic filler such as silica, mention may for example be made of silanol functional groups or polysiloxane functional groups having a silanol end (such as described, for example, in FR 2 740 778 or U.S. Pat. No. 6,013,718 and WO 2008/141702), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or else polyether groups (such as described, for example, in EP 1 127 909 or U.S. Pat. No. 6,503,973, WO 2009/000750 and WO 2009/000752).

As functional elastomers, mention may also be made of those prepared using a functional initiator, especially those bearing an amine or tin functional group (see, for example, WO 2010/072761).

Mention may also be made, as other examples of functionalized elastomers, of elastomers (such as SBR, BR, NR or IR) of the epoxidized type.

It will be noted that the SBR may be prepared as emulsion (ESBR) or as solution (SSBR). Whether it is ESBR or SSBR, use is especially made of an SBR having a moderate styrene content, for example of between 10% and 35% by weight, or a high styrene content, for example from 35% to 55%, a content of vinyl bonds of the butadiene part of between 15% and 70%, a content (mol %) of trans-1,4-bonds of between 15% and 75% and a Tg of between −10° C. and −65° C., preferably of greater than or equal to −50° C.

BRs having a content (mol %) of cis-1,4-linkages of greater than 90% are suitable as BR.

The composition advantageously comprises 100% of natural rubber or synthetic polyisoprene.

According to a preferred variant embodiment of the invention, the tread composition comprises a blend of natural rubber or of synthetic polyisoprene, at a content of 50 to 100 phr, and of BR at a content ranging from 10 to 50 phr.

The composition preferentially has a content of polyisoprene ranging from 60 to 90 phr and a content of BR ranging from 10 to 40 phr.

According to another variant embodiment of the invention, the composition comprises a blend of natural rubber or of synthetic polyisoprene, at a content of 50 to 100 phr, and of SBR at a content ranging from 10 to 50 phr.

The composition more preferentially has a content of polyisoprene ranging from 60 to 90 phr and a content of SBR ranging from 10 to 40 phr.

According to another variant embodiment of the invention, the composition comprises a blend of polyisoprene and of BR or SBR, and also a third diene elastomer different from the two first elastomers, chosen from polybutadienes, styrene-butadiene copolymers, isoprene-butadiene copolymers, isoprene-styrene copolymers and isoprene-butadiene-styrene copolymers.

The composition preferably thus has a content of polyisoprene ranging from 50 to 80 phr and comprises a BR at a content of 10 to 40 phr and an SBR at a content of 10 to 40 phr.

The composition according to the invention may contain another diene elastomer. The diene elastomers of the composition may be used in combination with any type of synthetic elastomer other than a diene elastomer, indeed even with polymers other than elastomers, for example thermoplastic polymers.

### Reinforcing Filler—Coupling Agent

A reinforcing filler is understood in a known way to mean a filler known for its abilities to reinforce a rubber composition which can be used for the manufacturing of tyres.

Among these reinforcing fillers are organic fillers, such as carbon black, and inorganic fillers.

The term “reinforcing inorganic filler” should be understood here to mean, in a known way, any inorganic or mineral filler, irrespective of its colour and its origin (natural or synthetic), also known as “white filler”, “clear filler” or else “non-black filler”, in contrast to carbon black, this inorganic filler being capable of reinforcing, by itself, without means other than an intermediate coupling agent, a rubber composition intended for the manufacture of a tyre tread, in other words capable of replacing, in its reinforcing role, a conventional tyre-grade carbon black for a tread. Such a filler is generally characterized by the presence of functional groups, especially hydroxyl (—OH) functional groups, at its surface, requiring in that regard the use of a coupling agent or system intended to provide a stable chemical bond between the elastomer and said filler.

Mention may be made, as reinforcing inorganic filler, of fillers of the siliceous type, such as silica, or of the aluminous, silica-alumina or titanium oxide type.

The total content of total reinforcing filler is preferably between 20 and 150 phr, the optimum content being different depending on the particular applications targeted, as is known. According to a favoured embodiment, the total content of reinforcing filler ranges from 30 to 90 phr, preferably from 40 to 80 phr, and even more preferentially from 45 to 70 phr.

The reinforcing filler for the composition in accordance with the invention predominantly comprises an inorganic filler, preferably silica. The inorganic filler preferably represents at least 60% by weight of the reinforcing filler, more preferentially the inorganic filler represents at least 75% by weight of the reinforcing filler, and even more preferentially the inorganic filler represents at least 90% of the reinforcing filler.

According to a preferential embodiment of the invention, the composition optionally carbon black; when it is present, the carbon black is used at a content of less than 30 phr, preferably less than 15 phr, more preferentially less than or equal to 8 phr and even more preferentially less than or equal to 5 phr.

All reinforcing carbon blacks of the 100, 200 or 300 series (ASTM grades), such as, for example, the N115, N134, N234, N326, N330, N339, N347 or N375 blacks, or else, depending on the applications targeted, the blacks of higher series (for example, N400, N660, N683 or N772), are suitable as carbon blacks. The carbon blacks might, for example, be already incorporated in the isoprene elastomer in the form of a masterbatch (see, for example, applications WO 97/36724 or WO 99/16600).

The inorganic filler preferentially comprises silica, and even more preferentially it consists of silica.

The silica used may be any reinforcing silica known to those skilled in the art, especially any precipitated or fumed silica having a BET surface area and also a CTAB specific surface area both of less than 450 m²/g, preferably from 30 to 400 m²/g, especially between 60 and 300 m²/g. As highly dispersible precipitated silicas (“HDSs”), mention will be made, for example, of the Ultrasil 7000 and Ultrasil 7005 silicas from Degussa, the Zeosil 1165MP, Zeosil 1135MP, Zeosil 1115MP and Zeosil Premium 200MP silicas from Rhodia, the Hi-Sil EZ150G silica from PPG, the Zeopol 8715, 8745 and 8755 silicas from Huber and the silicas having a high specific surface area as described in application WO 03/016387.

It is specified that the CTAB specific surface area is determined according to French standard NF T 45-007 of November 1987 (method B).

As reinforcing inorganic filler, mention will also be made of mineral fillers of the aluminous type, in particular alumina (Al₂O₃) or aluminium (oxide)hydroxides, or else reinforcing titanium oxides, for example described in U.S. Pat. Nos. 6,610,261 and 6,747,087.

Use may also be made, as reinforcing filler, of any filler at least partially covered with silica; this may consist in particular of a carbon black, metal hydroxides, especially magnesium or aluminium hydroxides, or crosslinked polymer particles.

The carbon blacks covered partially or completely by silica by a post-treatment, or the carbon blacks modified in situ by silica such as, non-limitingly, the fillers sold by Cabot Corporation under the name Ecoblack™ CRX 2000 or CRX4000, or the fillers described in publications US2003040553 and WO9813428, are particularly suitable.

The physical state in which the reinforcing inorganic filler is provided is unimportant, whether it is in the form of a powder, microbeads, granules or else beads. Of course, reinforcing inorganic filler is also understood to mean mixtures of various reinforcing inorganic fillers, in particular of highly dispersible silicas as described above.

In order to couple the reinforcing inorganic filler, especially silica, to the diene elastomer, use is made, in a known way, of an at least bifunctional coupling agent (or bonding agent) intended to provide a sufficient connection, of chemical and/or physical nature, between the inorganic filler (surface of its particles) and the diene elastomer, in particular bifunctional organosilanes or polyorganosiloxanes.

Use is made in particular of silane polysulfides, referred to as “symmetrical” or “asymmetrical” depending on their specific structure, such as described, for example, in applications WO 03/002648 (or US 2005/016651) and WO 03/002649 (or US 2005/016650).

Particularly suitable, without the definition below being limiting, are silane polysulfides corresponding to the following general formula (II):

Z−A−Sₓ−A−Z, (II) in which:

x is an integer from 2 to 8 (preferably from 2 to 5);

the symbols A, which are identical or different, represent a divalent hydrocarbon-based radical (preferably a C₁-C₁₈ alkylene group or a C₆-C₁₂ arylene group, more particularly a C₁-C₁₀, especially C₁-C₄, alkylene, in particular propylene);

the symbols Z, which are identical or different, correspond to one of the three following formulae:

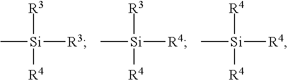

in which:

the radicals R³, which are substituted or unsubstituted and identical or different to one another, represent a C₁-C₁₈ alkyl, C₅-C₁₈ cycloalkyl or C₆-C₁₈ aryl group (preferably C₁-C₆ alkyl groups, cyclohexyl or phenyl, especially C₁-C₄ alkyl groups, more particularly methyl and/or ethyl),

the radicals R⁴, which are substituted or unsubstituted and identical or different to one another, represent a C₁-C₁₈ alkoxyl or C₅-C₁₈ cycloalkoxyl group (preferably a group chosen from C₁-C₈ alkoxyls and C₅-C₈ cycloalkoxyls, more preferentially still a group chosen from C₁-C₄ alkoxyls, in particular methoxyl and ethoxyl).

In the case of a mixture of alkoxysilane polysulfides corresponding to formula (II) above, especially the customary commercially available mixtures, the mean value of the “x”'s is a fractional number, preferably between 2 and 5, more preferentially close to 4. However, the invention may also advantageously be carried out for example with alkoxysilane disulfides (x=2).

Mention will more particularly be made, as examples of silane polysulfides, of bis((C₁-C₄)alkoxyl(C₁-C₄)alkylsilyl(C₁-C₄)alkyl) polysulfides (in particular disulfides, trisulfides or tetrasulfides), such as, for example, bis(3-trimethoxysilylpropyl) or bis(3-triethoxysilylpropyl) polysulfides. Use is made in particular, among these compounds, of bis(3-triethoxysilylpropyl) tetrasulfide, abbreviated to TESPT, of formula [(C₂H₅O)₃Si(CH₂)₃S₂]₂, or bis(triethoxysilylpropyl) disulfide, abbreviated to TESPD, of formula [(C₂H₅O)₃Si(CH₂)₃S]₂. Mention will also be made, as preferential examples, of bis(mono(C₁-C₄)alkoxyldi(C₁-C₄)alkylsilylpropyl) polysulfides (in particular disulfides, trisulfides or tetrasulfides), more particularly bis(monoethoxydimethylsilylpropyl) tetrasulfide, such as described in the abovementioned patent application WO 02/083782 (or U.S. Pat. No. 7,217,751).

Mention will especially be made, as examples of coupling agents other than an alkoxysilane polysulfide, of bifunctional POSs (polyorganosiloxanes), or else of hydroxysilane polysulfides (R⁴ =OH in the above formula II), such as described, for example, in patent applications WO 02/30939 (or U.S. Pat. No. 6,774,255), WO 02/31041 (or US 2004/051210) and W02007/061550, or else of silanes or POSs bearing azodicarbonyl functional groups, such as described, for example, in patent applications WO 2006/125532, WO 2006/125533 and WO 2006/125534.

Mention will be made, as examples of other silane sulfides, for example, of silanes bearing at least one thiol (—SH) functional group (“mercaptosilanes”) and/or at least one blocked thiol functional group, such as described, for example, in patents or patent applications U.S. Pat. No. 6,849,754, WO 99/09036, WO 2006/023815, WO 2007/098080.

Of course, use may also be made of mixtures of the coupling agents described previously, as described especially in the abovementioned application WO 2006/125534.

The content of coupling agent is advantageously less than 20 phr, it being understood that it is generally desirable to use as little as possible thereof. Typically, the content of coupling agent represents from 12% to 20% by weight relative to the amount of inorganic filler, in this case silica. Its content is preferentially ranges from 12% to 16%, and more preferentially still from 13% to 16%.

According to another variant of the invention, the reinforcing filler may comprise another organic filler, such as, for example, functionalized polyvinylaromatic organic fillers as described in applications WO-A-2006/069792 and WO-A-2006/069793, then respecting a total content of organic filler of less than 20 phr, preferably less than 10 phr, more preferentially less than or equal to 8 phr and even more preferentially less than or equal to 5 phr.

Inert (i.e. non-reinforcing) fillers, such as particles of clay, bentonite, talc, chalk, kaolin, at a content of less than or equal to 10 phr and preferentially less than or equal to 5 phr, may also be added to the reinforcing filler described above.

### Various Additives

The rubber compositions in accordance with the invention may also comprise all or a portion of the usual additives generally used in the elastomer compositions intended for the manufacture of tyres, in particular of treads, such as, for example, plasticizing agents or extending oils, whether the latter are aromatic or non-aromatic in nature, pigments, protection agents, such as antiozone waxes, chemical antiozonants or antioxidants, antifatigue agents, reinforcing resins, methylene acceptors (for example phenolic novolak resin) or methylene donors (for example HMT or H3M), as described, for example, in Application WO 02/10269 (or US2003-0212185), a crosslinking system based either on sulfur or on sulfur-donating agents and/or on peroxide and/or on bismaleimides, vulcanization accelerators or vulcanization activators, with zinc-based activators of course being excluded.

Preferably, these compositions comprise, as preferred non-aromatic or very weakly aromatic plasticizing agent, at least one compound selected from the group consisting of naphthenic oils, paraffinic oils, MES oils, TDAE oils, glycerol esters (in particular trioleates), plasticizing hydrocarbon resins having a high Tg preferably of greater than 30° C., and the mixtures of such compounds.

Mention will especially be made, among the above plasticizing hydrocarbon resins (it will be remembered that the name “resin” is reserved by definition for a solid compound), of resins formed of homo- or copolymers of alpha-pinene, beta-pinene, dipentene or polylimonene, C₅ fraction, for example formed of C₅ fraction/styrene copolymer, which can be used alone or in combination with plasticizing oils, such as MES or TDAE oils.

The overall content of such a plasticizing agent is less than or equal to 10 phr and preferably less than or equal to 5 phr, and even more preferentially less than or equal to 2 phr.

### Manufacture of the Rubber Compositions

The rubber compositions of the invention are manufactured in appropriate mixers, using two successive phases of preparation according to a general procedure well known to those skilled in the art: a first phase of thermomechanical working or kneading (sometimes referred to as a “non-productive” phase) at high temperature, up to a maximum temperature of between 130° C. and 200° C., preferably between 145° C. and 185° C., followed by a second phase of mechanical working (sometimes referred to as a “productive” phase) at lower temperature, typically below 120° C., for example between 60° C. and 100° C., during which finishing phase the crosslinking or vulcanization system is incorporated.

According to a preferential embodiment of the invention, all the base constituents of the compositions of the invention, with the exception of the vulcanization system, namely the reinforcing filler and the coupling agent where appropriate, are intimately incorporated, by kneading, in the diene elastomer during the first “non-productive” phase, that is to say that at least these various base constituents are introduced into the mixer and are thermomechanically kneaded, in one or more steps, until the maximum temperature of between 130° C. and 200° C., preferably of between 145° C. and 185° C., is reached.

By way of example, the first (non-productive) phase is carried out in a single thermomechanical step during which all the necessary constituents, the optional supplementary covering agents or processing aids and various other additives, with the exception of the vulcanization system, are introduced into an appropriate mixer, such as an ordinary internal mixer. The total duration of the kneading, in this non-productive phase, is preferably between 1 and 15 min. After cooling the mixture thus obtained during the first non-productive phase, the vulcanization system is then incorporated at low temperature, generally in an external mixer, such as an open mill; everything is then mixed (productive phase) for a few minutes, for example between 2 and 15 min.

The vulcanization system proper is preferentially based on sulfur and on a primary vulcanization accelerator, in particular on an accelerator of the sulfenamide type. Various known secondary vulcanization accelerators or vulcanization activators, such as, for example, zinc oxides, stearic acid or equivalent compounds, guanidine derivatives (in particular diphenylguanidine), or alternatively, known vulcanization retarders may be added to this vulcanization system, incorporated during the first non-productive phase and/or during the productive phase.

The sulfur is used at a preferential content of between 0.5 and 12 phr, in particular between 1 and 10 phr. The primary vulcanization accelerator is used at a preferential content of between 0.5 and 10 phr, more preferentially of between 0.5 and 5.0 phr.

Thiuram polysulfides, such as tetrabenzylthiuram disulfide (TBzTD), tetramethylthiuram disulfide (TMTD), dipentamethylenethiuram tetrasulfide (DPTT) are also suitable as sulfur donors. The content thereof is adjusted so as to reach the preferential equivalent sulfur contents indicated above.

Use may be made, as (primary or secondary) accelerator, of any compound capable of acting as accelerator of the vulcanization of diene elastomers in the presence of sulfur, especially accelerators of the thiazole type and their derivatives, and accelerators of sulfenamide, thiuram, dithiocarbamate, dithiophosphate, thiourea and xanthate type. As examples of such accelerators, mention may especially be made of the following compounds: 2-mercaptobenzothiazole disulfide (abbreviated to MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), tetrabenzylthiuram disulfide (TBZTD), zinc dibenzyldithiocarbamate (ZBEC), 1-phenyl-2,4-dithiobiuret (DTB), zinc dibutylphosphorodithioate (ZBPD), zinc 2-ethylhexylphosphordithioate (ZDT/S), O,O-di(2-ethylhexyl)thiophosphonyl disulfide (DAPD), dibutylthiourea (DBTU), zinc isopropyl xanthate (ZIX) and the mixtures of these compounds.

The final composition thus obtained is subsequently calendered, for example in the form of a sheet or a slab, especially for laboratory characterization, or else extruded in the form of a rubber profiled element which can be used, for example, as a tyre tread.

### III. EXEMPLARY EMBODIMENTS OF THE INVENTION

### Preparation of the Rubber Compositions

The following tests are carried out in the following way: the diene elastomer (NR and BR blend), the reinforcing filler(s), the coupling agent, and then, after kneading for one to two minutes, the various other ingredients, with the exception of the vulcanization system, are introduced into an internal mixer which is 70% filled and which has an initial vessel temperature of approximately 90° C. Thermomechanical working is then carried out (non-productive phase) in one step (total duration of the kneading equal to approximately 5 min), until a maximum “dropping” temperature of approximately 165° C. is reached. The mixture thus obtained is recovered and cooled and then the vulcanization system (sulfur and sulfenamide accelerator) are added on an external mixer (homofinisher) at 70° C., everything being mixed (productive phase) for approximately 5 to 6 min.

The compositions thus obtained are subsequently calendered, either in the form of slabs (thickness of 2 to 3 mm) or of thin sheets of rubber, for the measurement of their physical or mechanical properties.

### Test

The aim of this example is to show the improvement in properties obtained for tyre tread compositions in accordance with the invention, relative to a “conventional” control tread composition for heavy-goods vehicles.

The compositions were manufactured in accordance with the process described in detail in the previous section. These compositions are listed in the following Table 1 (where the amounts are expressed in phr, parts by weight per hundred parts of elastomer).

TABLE 1

| Composition: | A | B | C | D |
|---|---|---|---|---|
| NR (1) | 80 | 80 | 80 | 80 |
| BR (2) | 20 | 20 | 20 | 20 |
| Carbon black (3) | 3 | 3 | 3 | 3 |
| Silica (4) | 57 | 57 | 57 | 57 |
| Coupling agent (5) | 5.7 | 6.8 | 8.0 | 11.4 |
| Wax | 1 | 1 | 1 | 1 |
| Antioxidant (6) | 1.5 | 1.5 | 1.5 | 1.5 |
| ZnO | 2.7 | 2.7 | 1.7 | 2.7 |
| Stearic acid | 2.5 | 2.5 | 2.5 | 2.5 |
| Sulfur | 1.5 | 1.5 | 1.5 | 1.5 |
| Accelerator (7) | 1.8 | 1.8 | 1.8 | 1.8 |

(1) Natural rubber;
(2) BR with 4.3% of 1,2-; 2.7% of trans-; 93% of cis-1,4- (Tg = −106° C.);
(3) Carbon black N234 sold by Cabot Corporation;
(4) Silica, Zeosil 1165MP sold by Rhodia;
(5) TESPT coupling agent (Si69 from Evonik);
(6) N-(1,3-Dimethylbutyl)-N-phenyl-para-phenylenediamine (Santoflex 6-PPD from Flexsys);
(7) N-Cyclohexyl-2-benzothiazole sulfenamide (Santocure CBS from Flexsys).

The compositions A, B, C and D are thus defined as follows:
the control composition A is a “conventional” tread composition for tyres of heavy-goods vehicles, including 10% by weight of coupling agent relative to the amount of silica,
the composition B in accordance with the invention is a composition identical to the composition A apart from the amount of coupling agent which represents approximately 12% by weight relative to the amount of silica,
the composition C in accordance with the invention is a composition identical to the composition A apart from the amount of coupling agent which represents approximately 14% by weight relative to the amount of silica,
the composition D in accordance with the invention is a composition identical to the composition A apart from the amount of coupling agent which represents approximately 20% by weight relative to the amount of silica.

The rubber properties of these four compositions are measured before curing and after curing at 130° C. for 60 minutes; the results obtained are given in Table 2.

TABLE 2

| Composition: | A | B | C | D |
|---|---|---|---|---|
| Properties before curing | | | | |
| Mooney | 72 | 70 | 67 | 70 |
| Properties after curing | | | | |
| Tan (δ)max | 0.09 | 0.08 | 0.08 | 0.07 |
| G* | 1.62 | 1.85 | 1.95 | 2.21 |

Surprisingly, for each of the compositions B, C and D in accordance with the invention, compared to the control composition A, both a slight improvement in the properties before curing (lower Mooney value) and a significant improvement in the properties after curing (decreased tan (δ) max value and increased G* stiffness value) were observed. Moreover, it is also noted, relative to the range of the content of coupling agent of 12%-20% illustrated by this test, that by moving away from the two limit values, a more significantly improved compromise of properties is obtained.

1) Tyre tread having a rubber composition based on at least on at least one natural or synthetic polyisoprene, at a content ranging from 50 phr to 100 phr, a reinforcing filler predominantly comprising an inorganic filler by weight, a coupling agent, a plasticizing agent at a content of less than or equal to 10 phr and a sulfur-based crosslinking system, characterized in that the coupling agent consists of a silane polysulfide and in that the silane content of the composition ranges from 12% to 20% by weight relative to the amount of inorganic filler.

2) Tread according to claim 1, in which the composition likewise comprises a polybutadiene, BR, or a butadiene-styrene copolymer, SBR, the content of polyisoprene ranging from 50 phr to 90 phr.

3) Tread according to either one of claims 1 and 2, in which the inorganic filler comprises silica.

4) Tread according to either one of claims 1 and 2, in which the inorganic filler consists of silica.

5) Tread according to any one of the preceding claims, in which the silane content ranges from 12% to 16% by weight relative to the amount of inorganic filler.

6) Tread according to any one of the preceding claims, in which the silane content ranges from 13% to 16% by weight relative to the amount of inorganic filler.

7) Tread according to any one of the preceding claims, in which the inorganic filler represents at least 60% by weight of the reinforcing filler.

8) Tread according to any one of claims 1 to 6, in which the inorganic filler represents at least 75% by weight of the reinforcing filler.

9) Tread according to any one of claims 1 to 6, in which the inorganic filler represents at least 90% of the reinforcing filler.

10) Tread according to any one of claims 2 to 9, in which the content of BR or of SBR ranges from 10 to 50 phr.

11) Tread according to any one of claims 2 to 10, in which the content of polyisoprene ranges from 60 to 90 phr and the composition comprises a BR or an SBR at a content of 10 to 40 phr.

12) Tread according to any one of claims 2 to 11, in which the composition comprises a third diene elastomer different from the two first elastomers, chosen from polybutadienes, styrene-butadiene copolymers, isoprene-butadiene copolymers, isoprene-styrene copolymers and isoprene-butadiene-styrene copolymers.

13) Tread according to any one of the preceding claims, in which the total content of reinforcing filler ranges from 30 to 90 phr.

14) Tread according to any one of the preceding claims, in which the total content of reinforcing filler ranges from 40 to 80 phr, preferably from 45 to 70 phr.

15) Tread according to any one of the preceding claims, in which the content of plasticizing agent is less than or equal to 5 phr.

16) Tread according to claim 15, in which the content of plasticizing agent is less than or equal to 2 phr.

17) Tyre comprising a tread according to any one of claims 1 to 16.
